(19) United States
(12) Patent Application Publication
(10) Pub. No.: US 2014/0279115 A1
(43) Pub. Date: Sep. 18, 2014

(54) MOBILE PAYMENT USING CLOUD COMPUTING

(71) Applicant: SAMSUNG ELECTRONICS CO., LTD., Suwon (KR)

(72) Inventors: Sanjeev Verma, San Jose, CA (US); Onur Aciicmez, Santa Clara, CA (US); Byung-Rae Lee, Seoul (KR)

(73) Assignee: SAMSUNG ELECTRONICS CO., LTD., Suwon (KR)

(21) Appl. No.: 13/841,282

(22) Filed: Mar. 15, 2013

(51) Int. Cl. G06Q 20/32

(52) U.S. Cl. CPC G06Q 20/322
USPC 705/21; 705/44; 705/39

(57) ABSTRACT

A method for mobile payment selecting a payment method for a purchase request using an application, sending a request including identification information for the selected payment method to a financial entity server in a cloud computing environment, responding to an attestation request sent from the financial entity server to the application, providing mobile subscriber information to the financial entity server from a network operator, receiving a signed digital certificate for the selected payment method from the financial entity server, sending the digital certificate for payment processing from the electronic device to a payment method reader, and completing the purchase request upon verification of the digital certificate.

### TECHNICAL FIELD

One or more embodiments relate generally to mobile payment and, in particular, to mobile payment using cloud computing.

### BACKGROUND

Credit card payment typically uses a four party payment system including the bank customer/cardholder that desires to obtain goods or services, a merchant or retailer that uses a point-of-service (POS) card reader and provides goods or services, the issuer (e.g., bank) that provides the customer with a means to pay for the goods or services (e.g., through billing, online payment options, etc.), and the Acquirer with whom the merchant interacts to receive funds for the goods or services.

### SUMMARY

In one embodiment, a method provides mobile payment. One embodiment comprises a method that comprises selecting a payment method for a purchase request using an application. In one embodiment, a request that includes identification information for the selected payment method is sent to a financial entity server in a cloud computing environment. In one embodiment, an attestation request sent from the financial entity server to the application is responded to. In one embodiment, mobile subscriber information is provided to the financial entity server from a network operator. In one embodiment, a signed digital certificate for the selected payment method is received from the financial entity server by the application. In one embodiment, the digital certificate is sent for payment processing to a payment reader from the electronic device. In one embodiment, the purchase request is completed upon verification of the digital certificate.

Another embodiment provides a method for mobile payment comprising selecting a method for payment of a purchase request using an application on an electronic device. In one embodiment, information for the selected payment method is transmitted to a payment reader for authorizing the purchase request. In one embodiment, the purchase request is sent to a financial entity server in a cloud computing environment by the payment reader. In one embodiment, the purchase request is processed by the financial entity server based on identifying the electronic device, and the financial entity server sends an attestation request to the electronic device. In one embodiment, remote attestation is performed by the electronic device and a response is transmitted to the remote attestation to the financial entity server. In one embodiment, the attestation response is processed by the financial entity server for verifying the electronic device. In one embodiment, a verification request sent by the financial entity server is responded to by the electronic device to verify the purchase request. In one embodiment, the purchase request is completed based on a response to the verification request from the electronic device.

One embodiment provides a system for mobile payment. In one embodiment, an electronic device comprises a secure execution environment for an application. In one embodiment, digital payment methods are stored in secured storage. In one embodiment, a near field communication (NFC) interface passes digital credit card information from the mobile application for digital payment method purchases.

Another embodiment provides a non-transitory computer-readable medium having instructions which when executed on a computer perform a method comprising: selecting a payment method from a list of payment methods for payment of a purchase request using an application on a mobile electronic device. In one embodiment, information for the selected payment method is transmitted from the mobile electronic device to a payment reader for authorizing the purchase request using near field communication (NFC) for the transmitting communication. In one embodiment, the purchase request is verified using a financial entity server in a cloud computing environment. In one embodiment, the purchase request is completed upon verification of a digital certificate for the selected digital credit card or verification of the mobile electronic device.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of an architecture system for mobile payment using an electronic device, according to an embodiment.

FIG. 3 shows an e-wallet including digital credit card architecture for mobile payment using an electronic device, according to an embodiment.

FIG. 4 shows an architecture of a cloud computing environment for mobile payment using an electronic device, according to an embodiment.

FIG. 5 shows another architecture of a cloud computing environment for mobile payment using an electronic device, according to an embodiment.

FIG. 6 shows a flow diagram for mobile payment using an electronic device, according to an embodiment.

FIG. 7 shows another flow diagram for mobile payment using an electronic device, according to an embodiment.

FIG. 8 is a high-level block diagram showing an information processing system comprising a computing system implementing an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to payment for point-of-service (POS) purchases using an electronic device. In one embodiment provides secured purchasing using digital credit card information for a selected credit card from a list of credit cards using an electronic device. In one embodiment, the electronic device comprises a mobile electronic device capable of data communication over a communication link, such as a wireless communication link. Examples of such mobile device include a mobile phone device, a mobile tablet device, etc.

In one embodiment, a method provides mobile payment using an electronic device. One embodiment comprises a method that comprises selecting a payment method for a purchase request using an application. In one embodiment, a request that includes identification information for the selected payment method is sent to a financial entity server in a cloud computing environment. In one embodiment, an attestation request sent from the financial entity server to the application is responded to. In one embodiment, mobile subscriber information is provided to the financial entity server from a network operator. In one embodiment, a signed digital certificate for the selected payment method is received from the financial entity server by the application. In one embodiment, the digital certificate is sent for payment processing to a payment reader from the electronic device. In one embodiment, the purchase request is completed upon verification of the digital certificate.

Another embodiment provides method for mobile payment using an electronic device, wherein the method comprises selecting a method for payment of a purchase request using an application on an electronic device. In one embodiment, information for the selected payment method is transmitted to a payment reader for authorizing the purchase request. In one embodiment, the purchase request is sent to a financial entity server in a cloud computing environment by the payment reader. In one embodiment, the purchase request is processed by the financial entity server based on identifying the electronic device and the financial entity server sends an attestation request to the electronic device. In one embodiment, remote attestation is performed by the electronic device and a response is transmitted to the remote attestation to the financial entity server. In one embodiment, the attestation response is processed by the financial entity server for verifying the electronic device. In one embodiment, a verification request sent by the financial entity server is responded to by the electronic device to verify the purchase request. In one embodiment, the purchase request is completed based on a response to the verification request from the electronic device.

One or more embodiments address the security in a mobile payment ecosystem by using Trusted Computing Technology (TCG) and a private cloud computing environment managed and trusted by financial institutions (e.g., credit card issuers). In one embodiment, a security issue arising out of a theft of a mobile device is handled by maintaining minimal information stored on the mobile device. One embodiment provides for replacement of plastic credit cards by digital credit cards, such as digital certificates signed by the issuing banks. In one embodiment, a host of a mobile payment application (e.g., a mobile e-wallet application) and digital credit cards issued to a subscriber in the private cloud computing environment is trusted by banks and other financial institutions. In one embodiment, the private cloud computing environment supports a trusted entity that is trusted by all stakeholders (e.g., financial institutions). In one embodiment, trusted computing-based technologies are used to securely install, authenticate, and authorize a mobile e-wallet application in the mobile electronic device.

In one embodiment, the installation and management of a mobile payment application in the mobile electronic device takes place directly between the private cloud computing environment (e.g., of financial institutions) without any involvement of a mobile network operator (MNO). In another embodiment, the mobile payment application is installed by the MNO, and the authentication and authorization of the mobile payment application occurs through a secure interface (e.g., application programming interfaces (APIs)) between the MNO and the private cloud computing environment.

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols may include, for example, GSM, GSM plus EDGE, CDMA, quadband, and other cellular protocols. In another example, a long range communications protocol may include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a cellular telephone or a landline telephone, a personal e-mail or messaging device with audio and/or video capabilities, pocket-sized personal computers such as an iPAQ Pocket PC, available by Hewlett Packard Inc., of Palo Alto, Calif., personal digital assistants (PDAs), a desktop computer, a laptop computer, tablet computers, pad-type computing devices, a media player, and any other device capable of communicating wirelessly (with or without the aid of a wireless-enabling accessory system) or via wired pathways (e.g., using traditional telephone wires). The communications operations may include any suitable form of communication, including for example, voice communication (e.g., telephone calls), data communication (e.g., e-mails, text messages, media messages), near field communication (NFC), or combinations of these (e.g., video conferences).

FIG. 2 shows a functional block diagram of an architecture system 100 that may be used for mobile payment using an electronic device 120, according to an embodiment. Both transmitting device 12 and receiving device 11 may include some or all of the features of electronics device 120. In one embodiment, the electronic device 120 may comprise a display 121, a microphone 122, an audio output 123, an input mechanism 124, communications circuitry 125, control circuitry 126, a camera 127, a global positioning system (GPS) receiver module 118, an NFC interface 129, and any other suitable components. In one embodiment, a mobile payment application 130 (e.g., an e-wallet application) executes on the electronic device 120. In one embodiment, an e-wallet table or list 140 stores multiple digital credit cards 1-N 145 for a user's available credit cards, where N is a positive integer equal to or greater than 2. In one embodiment, the electronic device 120 may communicate with the private cloud computing environment 160 that comprises financial entities (e.g., banks, credit card issuers, etc.) that process credit cards and use thereof. In one embodiment, the NFC interface 129 communicates with the NFC device 150 that may be coupled with or part of a POS system that accepts credit card payments for a merchant. In one embodiment, an MNO 170 may be responsible for installing the mobile application 130 and providing authorization for payment requests from the electronic device 120 by communicating with the private cloud computing environment 160.

In one embodiment, all of the applications employed by an audio output 123, a display 121, an input mechanism 124, communications circuitry 125 and a microphone 122 may be interconnected and managed by control circuitry 126. In one embodiment, the audio output 123 may include any suitable audio component for providing audio to the user of the electronics device 120. For example, the audio output 123 may include one or more speakers (e.g., mono or stereo speakers) built into the electronics device 120. In some embodiments, the audio output 123 may include an audio component that is remotely coupled to electronics device 120. For example, the audio output 123 may include a headset, headphones or earbuds that may be coupled to communications device with a wire (e.g., coupled to the electronics device 120 with a jack) or wirelessly (e.g., Bluetooth® headphones or a Bluetooth® headset).

In one embodiment, the display 121 may include any suitable screen or projection system for providing a display visible to the user. For example, the display 121 may include a screen (e.g., an LCD screen) that is incorporated in electronics device 120. As another example, the display 121 may include a movable display or a projecting system for providing a display of content on a surface remote from the electronics device 120 (e.g., a video projector). The display 121 may be operative to display content (e.g., information regarding communications operations or information regarding available media selections) under the direction of control circuitry 126.

In one embodiment, the input mechanism 124 may be any suitable mechanism or user interface for providing user inputs or instructions to the electronics device 120. The input mechanism 124 may take a variety of forms, such as a button, keypad, dial, a click wheel, or a touch screen. The input mechanism 124 may include a multi-touch screen. The input mechanism 124 may include a user interface that may emulate a rotary phone or a multi-button keypad, which may be implemented on a touch screen or the combination of a click wheel or other user input device and a screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, flash memory, ROM, and/or RAM. In some embodiments, the memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an ASR application, a dialog application, a map application, a media application (e.g., QuickTime®, MobileMusic.app, or MobileVideo.app). In some embodiments, the electronics device 120 may include one or several applications operative to perform communications operations. For example, the electronics device 120 may include a messaging application, a mail application, a telephone application, a voicemail application, an instant messaging application (e.g., for chatting), a videoconferencing application, a fax application, or any other suitable application for performing any suitable communications operation.

In some embodiments, the electronics device 120 may include a microphone 122. For example, electronics device 120 may include the microphone 122 to allow the user to transmit audio (e.g., voice audio) during a communications operation or as a means of establishing a communications operation or as an alternate to using a physical user interface. The microphone 122 may be incorporated in electronics device 120, or may be remotely coupled to the electronics device 120. For example, the microphone 122 may be incorporated in wired headphones, or the microphone 122 may be incorporated in a wireless headset.

In one embodiment, the electronics device 120 may include any other component suitable for performing a communications operation. For example, the electronics device 120 may include a power supply, ports, or interfaces for coupling to a host device, a secondary input mechanism (e.g., an ON/OFF switch), or any other suitable component.

In one embodiment, a user may direct the electronics device 120 to perform a communications operation using any suitable approach. As one example, a user may receive a communications request from another device (e.g., an incoming telephone call, an email or text message, an instant message) and may initiate a communications operation by accepting the communications request. As another example, the user may initiate a communications operation by identifying another communications device and transmitting a request to initiate a communications operation (e.g., dialing a telephone number, sending an email, typing a text message, or selecting a chat screen name and sending a chat request).

In one embodiment, the electronic device 120 may comprise a mobile device that may utilize mobile device hardware functionality including: the display 121, the GPS receiver module 132, the camera 131, a compass module, and an accelerometer and gyroscope module. The GPS receiver module 132 may be used to identify a current location of the mobile device (i.e., user). The compass module is used to identify direction of the mobile device. The accelerometer and gyroscope module is used to identify tilt of the mobile device. In other embodiments, the electronic device may comprise a television or television component system.

FIG. 3 shows an example e-wallet table or list 140 that stores a list of digital credit cards 1-N 145 for a user's available credit cards for mobile payment using the electronic device 120, according to an embodiment. In one embodiment, digital credit cards 1-N 145 act as a replacement of plastic credit cards, and comprise digital certificates signed by the issuing banks or financial institution, or credit authorizer (CA) of the issuing banks or financial institution. In one embodiment, the digital credit cards 1-N 145 comprise all of the information that is encoded by the banks or credit card issuers in the magnetic strip of an equivalent plastic credit card, such as issuing bank name, cardholder name, credit card number, expiration date, user personal identification number (PIN), authorized spending amount, random characters (e.g., bank-specific for challenge), policy (e.g., allowed storage time), digital signature, etc.

In one embodiment, the digital credit cards 1-N 145 may include an additional bank-specific policy element. In one example, the policy may specify whether the digital credit card 1-N 145 may be stored on the electronic device 120 for a certain time period. In one example, a particular bank may allow the storage of the digital credit card 1-N 145 on the electronic device 120 for 24 hours after the download. In this example, after 24 hours, the mobile application 130 automatically deletes the signed certificate or authorization for the digital credit card 1-N 145.

FIG. 4 shows an architecture of a cloud computing environment 160 for mobile payment using an electronic device 120, according to an embodiment. In one embodiment, the hosting of the mobile application 130 and storage of an e-wallet module 430 and digital credit cards 1-N 145 (issued as digital certificates) are provided in the private cloud computing environment 160, where credit card issuers 410 (e.g., financial institutions) provide the processing for their respective issued digital credit cards 1-N 145. In one embodiment, the cloud computing environment is private and only hosted by a numbers of banks and financial institutions (e.g., credit card issuers 410).

In one embodiment, the private cloud computing environment 160 hosts mobile financial applications for their respective customers. In one embodiment, the private cloud computing environment 160 also hosts a root credit authorization (CA) 440 that signs digital credit cards 1-N 145 when a payment/purchase request for a particular credit card from the user is made. In one embodiment, the private cloud computing environment 160 provides an identity provider 420 (IdP) to authenticate a holder of a credit card. In one embodiment, the user of a digital credit card 1-N 145 may be identified by a digital identity, such as a financial user identification (financialUserID), etc.

FIG. 5 shows an architecture of the private cloud computing environment 160 and the electronic device 120, according to an embodiment. In one embodiment, the mobile e-wallet table or list 140 may be installed in the electronic device 120 either from a server hosted by the MNO 170 or the private cloud computing environment 160. In one embodiment, the mobile application 130 on the electronic device 120 is developed and deployed by device manufacturers, such as Samsung®. In other embodiments, all the stakeholders (involved in the payment processing) may jointly develop requirements and standard protocols.

In one embodiment, device manufacturers may develop mobile wallet technologies based on the specifics of their devices (e.g., using a mobile trusted module (MTM)/trusted platform module (TPM), Trustzone or any other relevant technology). In one embodiment, financial institutions may develop their own technologies on the cloud side that may function properly in a mobile wallet ecosystem by following standards.

In one embodiment, the mobile application 130 in the electronic device 120 has a counterpart in the private cloud computing environment 160 of financial institutions. In one embodiment, the mobile application 130 in the electronic device 120 maintains the e-wallet table or list 140 of the credit cards owned by the user. In one embodiment, each credit card is identified by a credit card identifiers 1-N (ccID 1-N) 520, where N is a positive integer greater or equal to 2. In one embodiment, the ccID 1-N 520 may comprise a hash of the digital credit card 1-N 145 (e.g., digital certificate). In one embodiment, when the ccIDs 1-N 520 are stored on the electronic device instead of the actual credit card information, the actual credit card information (e.g., digital certificate) is stored in the private cloud computing environment 160 of financial institutions.

In one embodiment, a mobile wallet application in the private cloud computing environment maintains a table or list of the digital credit cards 1-N 145 owned by every user identified by a financialUserID 510. In this embodiment, the main difference is that the table or list of digital credit cards 1-N 145 also contains the actual digital certificate owned by the user (e.g., not a hash).

In one embodiment, Trusted Computing (TC) based technologies are used to authenticate and authorize the mobile application 130 in the electronic device 120. In one implementation, financial institutions may desire delivering digital credit cards 1-N 145 to a mobile device running an authorized mobile wallet application. In one example, the digital credit card 1-N 145 is only to be used on an authorized mobile device (e.g., electronic device 120). In one embodiment, TC-based technology (e.g., presence of trusted platform module (TPM)/mobile trusted module (MTM) chip in the electronic device 120) for the remote software attestation of the mobile application 130 running in the electronic device 120 by a financial institution server in the private cloud computing environment 160.

In one embodiment, mobile users are reliably identified by financial institutions and/or MNOs 170. In one embodiment, financial institutions and/or MNOs 170 may assign identities to users. In one example, a mobile user may have two types of identities: (1) financialUserID 510: a server in the financial institution private cloud environment 160 identifies the credit card owner through this identification (ID); and (2) mobileUserID: where an MNO 170 identifies the mobile user through this ID. In this embodiment, identification relies on the assigned ID values and a user may use the same ID value on multiple electronic devices.

In one embodiment, identities are tied to specific hardware devices (e.g., electronic device 120). In one embodiment, if an electronic device 120 employs TPM/MTM or a similar hardware chip, financial institutions may use the characteristics of the chip for identification and authentication purposes. In one embodiment, each TPM/MTM chip has unique keys that are used while performing trusted computing functions, such as remote attestation. In one embodiment, financial institutions may request the electronic device 120 to perform a remote attestation before authorizing any payment/purchase or transaction request. In this embodiment, the financial institutions may authenticate the electronic device 120 and ensure that the electronic device 120 is running a legitimate version of the mobile application 130 and the software stack below the mobile application 130. In this embodiment, the financial institutions may trust the purchase/transaction requests initiated by that electronic device 120.

In one embodiment, MNOs 170 may use already existing subscriber identity module (SIM) cards and international mobile equipment identity (IMEI) for identification and authorization purposes. In this embodiment, the MNOs 170 may leverage the same mechanisms they use when they get a phone call or short message service (SMS) request from a particular mobile device (e.g., electronic device 120).

FIG. 6 shows a flow diagram showing a process 600 for mobile payment using the electronic device 120, according to an embodiment. In one embodiment, in block 610, a mobile wallet application (e.g., mobile application 130, FIG. 1) is launched at a merchant POS machine/system, where a user selects a particular credit card (e.g., digital credit card 1-N 145) from a table or list of available credit cards (e.g., e-wallet table or list 140) to use for a purchase/payment. In one embodiment, the user launches the mobile wallet application manually by, for example, tapping on a touch screen (e.g., display 121). In one embodiment, the mobile device stores the list of digital credit cards of the device owner, where either the actual credit card information (e.g., actual digital certificate) or only a form of identifiers of the credit cards (e.g. ccIDs 520 or hash of the ccIDs 520).

In one embodiment, in block 620, the mobile application sends a request to a financial entity server in the private cloud containing a digital ID of the digital credit card. In one embodiment, the request includes both a financialUserID 510 and mobileUserID. In block 630, the mobile application executing on the mobile device receives an attestation request message containing a challenge (e.g., a 20 byte random challenge) sent by the financial entity server in the private cloud. In one embodiment, after the mobile application executing on the electronic device receives the attestation challenge in block 640, a secure sockets layer (SSL) connection is set up and the financial entity server of the private cloud communicates with the mobile application. In one embodiment, the private cloud server attests the mobile application by verifying the issuing CA (e.g., the private cloud CA) and cash register values.

In one embodiment, in block 650, the financial entity cloud server obtains the mobile subscriber information (IMEI, international mobile subscriber identity (IMSI), etc.) from the MNO 17 (identifying the mobile user through the mobileUserID), and creates a new certificate by including additional information and signing with the root CA hosted by the private cloud. In one embodiment, the new certificate disallows the use of the new certificate from a clone mobile device. In one embodiment, in block 660, a signed digital credit card (e.g., digital certificate) is received by the mobile wallet application over the SSL tunnel from the private cloud. In one embodiment, an associated policy document is also delivered, which allows the mobile device to maintain the digital credit card in the secure storage for a certain time period (e.g., 24 hours).

In one embodiment, in block 670, the mobile wallet application securely passes the selected digital credit card to an NFC reader over the NFC interface. In one embodiment, in block 680, the NFC reader verifies the CA of the bank and the CA of the private cloud. In one embodiment, the NFC reader also verifies that request has come from a valid mobile device. In one embodiment, the NFC reader then obtains the credit card information from the digital certificate. In one embodiment, the payment information is then sent to the issuing bank over the payment network. In one embodiment, the mobile wallet application in the mobile device may then either delete the digital card or store it in the secure storage for a certain period as defined by the policy in the associated policy document delivered along with the digital credit card.

FIG. 7 shows another flow diagram showing a process 700 for mobile payment using an electronic device 120, according to an embodiment. In one embodiment, for this flow diagram, the copies of the digital credit cards (e.g., digital credit cards 1-N 145) are stored in the mobile device (e.g., electronic device 120). In one embodiment, the mobile device may use one or a combination of the following: (1) TrustZone to provide secure storage and domain to run the mobile wallet application (e.g., mobile application 130) and store the digital credit cards; (2) TC primitives to ensure the integrity of the software (s/w) stack that runs the mobile wallet application and to provide secured (e.g., sealed or separated) storage for digital credit cards; or (3) a similar technology to provide isolated and integrity-protected execution environment for the mobile wallet application execution and secure storage for digital credit cards. In one embodiment, the financial institution server of the private cloud stores copies of the digital credit cards and the information of which devices and users are associated with which cards.

In one embodiment, in block 710, a mobile wallet application (e.g., mobile application 130, FIG. 1) is launched at a merchant POS machine/system, where a user selects a particular credit card (e.g., digital credit card 1-N 145) from a table or list of available credit cards (e.g., e-wallet table or list 140) to use for a purchase/payment. In one embodiment, the user launches the mobile wallet application manually by, for example, tapping on a touch screen (e.g., display 121). In one embodiment, in block 720, the mobile application passes the selected digital credit card to the merchant from an NFC interface to an NFC reader. In one embodiment, in block 730, the merchant sends the payment/purchase transaction request to the financial server of the private cloud to get an authorization for the transaction.

In one embodiment, in block 740, the financial server of the private cloud processes the transaction request, checks its records to identify the mobile device that is supposed to have this particular digital credit card. In one embodiment, the financial server of the private cloud then sends that mobile electronic device an attestation request (e.g., sends a challenge). In one embodiment, in block 750, the mobile device receives the attestation request and performs attestation (e.g., per TC requirements) and responds to the financial server of the private cloud. In one embodiment, in block 760, after receiving the attestation response, the financial private cloud processes the response to check the state of the s/w stack running on the mobile device. In one embodiment, in block 770, if the financial server of the private cloud verifies that the mobile device is running a trusted set of s/w, the financial server of the private cloud sends another message to the mobile device to verify that the purchase request actually comes from that mobile device.

In one embodiment, in block 780, the mobile device responds to the request for verification by either verifying the transaction or denying it. In one embodiment, in block 790, if the financial server of the private cloud receives verification from the mobile device, it authorizes the transaction request that came from the merchant and the transaction is processed (e.g., approved). Otherwise, the transaction is denied and the financial server of the private cloud sends the merchant a deny report.

In one embodiment, the financial server of the private cloud may send both the attestation request (e.g., block 740) and the transaction verification request (e.g., 770) to the mobile device in a single step instead of separate steps. In one embodiment, the mobile device may respond to both of these requests (e.g., attestation request and transaction verification request) at the same time instead of separately. In one embodiment, the transaction verification step between the financial server of the private cloud and the mobile device may also involve user authentication instead of the financial server of the private cloud only authenticating the mobile device. In one embodiment (e.g., in case of a theft), it is beneficial to authenticate the user along with the mobile device. In one embodiment, there are various ways to authenticate the user; for example, the financial server of the private cloud or mobile wallet application may request the user to enter a PIN or password, etc.

FIG. 8 is a high-level block diagram showing an information processing system comprising a computing system 500 implementing an embodiment. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as Wi-Fi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals to/from a plurality of sinks/sources, such as, the Internet 550, a mobile electronic device 551, a server 552, or a network 553, and may be implemented using wire or cable, fiber optics, a phone line, a cellular phone link, an radio frequency (RF) link, and/or other communication channels.

In one implementation, in a mobile wireless device such as a mobile phone, the system 500 further includes an image capture device such as a camera 15. The system 500 may further include application modules as MMS module 521, SMS module 522, email module 523, social network interface (SNI) module 524, audio/video (AV) player 525, web browser 526, image capture module 527, etc.

The system 500 further includes a mobile payment processing module 530 as described herein, according to an embodiment. In one implementation of mobile payment processing module 530 along with an operating system 529 may be implemented as executable code residing in a memory of the system 500. In another embodiment, such modules are in firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for mobile payment, comprising:
selecting a payment method for a purchase using an application;
sending a request including identification information for the selected payment method to a financial entity server in a cloud computing environment;
responding to an attestation request sent from the financial entity server to the application;
providing mobile subscriber information to the financial entity server from a network operator;
receiving a signed digital certificate for the selected payment method from the financial entity server;
sending the digital certificate for payment processing from the electronic device to a payment method reader; and
completing the purchase request upon verification of the digital certificate.

2. The method of claim 1, wherein selecting the payment method for the purchase request using the application comprises selecting a credit card from a stored list of one or more credit cards using the application.

3. The method of claim 2, wherein the stored list of credit cards comprises information for each credit card in the list of credit cards, wherein the information comprises one of actual credit card information, and a form of identifiers.

4. The method of claim 3, wherein the identification information comprises a financial user identification and mobile user identification.

5. The method of claim 3, wherein the attestation request comprises a random challenge sent from the financial entity server in the cloud computing environment.

6. The method of claim 5, further comprising forming a secure sockets layer (SSL) connection for communication between the application and the financial entity server in the cloud computing environment, wherein the financial entity server attests the application by verifying an issuing credit authorization (CA) and purchase value.

7. The method of claim 6, wherein the mobile subscriber information comprises one or more of international mobile equipment identity (IMEI) and international mobile subscriber identity (IMSI), wherein the network operator comprises a mobile network operator (MNO), and the mobile subscriber information is provided by the MNO.

8. The method of claim 7, wherein the signed digital certificate is a new digital certificate created by the financial entity server in the cloud computing environment and includes additional information from a previous digital certificate associated with the credit card and is signed with a root CA hosted by the cloud computing environment.

9. The method of claim 8, further comprising receiving a policy document by the mobile application for limiting storage time of the new digital certificate for the credit card in secure storage on the electronic device.

10. The method of claim 8, wherein sending the digital certificate for payment processing from the electronic device comprises passing the new digital certificate to a the payment method reader, wherein the payment method reader comprises a near field communication (NFC) reader, and the new digital certificate is passed over an NFC interface of the electronic device to the NFC reader, wherein the NFC reader obtains the credit card information from the new digital certificate.

11. The method of claim 10, wherein verification of the digital certificate comprises verification of the CA of the financial entity server and CA of the cloud computing environment, and verification that the purchase request is provided by a valid electronic device.

12. The method of claim 1, wherein the electronic device comprises a mobile phone.

13. A method for mobile payment, comprising:
selecting a method for payment of a purchase request using an application on an electronic device;
transmitting information for the selected payment method to a payment reader for authorizing the purchase request;
sending the purchase request to a financial entity server in a cloud computing environment by the payment reader;
processing the purchase request by the financial entity server based on identifying the electronic device, and the financial entity server sending an attestation request to the electronic device;
performing remote attestation by the electronic device and transmitting a response to the remote attestation to the financial entity server;
processing the attestation response by the financial entity server for verifying the electronic device;
responding to a verification request sent by the financial entity server by the electronic device to verify the purchase request; and
completing the purchase request by the financial entity server based on a response to the verification request from the electronic device.

14. The method of claim 13, wherein selecting the method for payment for the purchase request using the application on the electronic device comprises selecting a credit card from a stored list of one or more credit cards using the application.

15. The method of claim 14, wherein the stored list of credit cards comprises information for each credit card in the list of credit cards, wherein the information comprises actual credit card information.

16. The method of claim 15, wherein the financial entity in the cloud computing environment stores a copy of the actual credit card information for the selected credit card, and stores electronic device and user information associated with the selected credit card.

17. The method of claim 16, wherein transmitting the information for the selected payment method comprises passing the information for the selected credit card to a near field communication (NFC) reader over an NFC interface of the electronic device, wherein the NFC reader transmits the credit card information for the selected credit card to the financial entity server in the cloud computing environment for authorizing the purchase request.

18. The method of claim 17, wherein processing the purchase request based on identifying the electronic device comprises the financial entity server in the cloud computing environment verifying the received information for the selected credit card is associated with the electronic device.

19. The method of claim 18, wherein processing the attestation response for verifying the electronic device comprises the financial entity server in the cloud computing environment verifying that the electronic device is executing in a trusted state, and upon verifying that the electronic device is executing in the trusted state, transmitting a transaction verification request to the electronic device.

20. The method of claim 19, wherein the trusted state comprises the electronic device using secured storage and domain for executing the application in a protected execution environment, wherein the stored list of one or more credit cards is stored in the secured storage.

21. The method of claim 20, further comprising providing user authentication for the purchase request, wherein the financial entity server in the cloud computing environment authenticates the user of the electronic device.

22. The method of claim 19, wherein the electronic device comprises a mobile phone, and the cloud computing environment comprises a private cloud computing environment for credit card issuer processing.

23. A system for mobile payment, comprising:
an electronic device comprising a secure execution environment for an application, wherein digital payment methods are stored in secured storage; and
a near field communication (NFC) interface that passes payment method information from the mobile application for digital payment method purchases.

24. The system of claim 23, wherein the payment methods comprise digital credit cards, and the NFC interface passes digital credit card information to an NFC reader for a point-of-service (POS) system for requesting payment using a selected credit card from a list of stored digital credit cards stored in the secured storage.

25. The system of claim 23, wherein payment requests from the electronic device are authorized by a financial entity server in a private cloud computing environment based on authenticating the electronic device.

26. The system of claim 25, wherein the financial entity server in the private cloud computing environment stores a copy of actual credit card information for the selected credit card, and stores electronic device and user information associated with the selected credit card.

27. The system of claim 26, wherein the financial entity server in the private cloud environment authenticates payment requests from the electronic device by verifying that the electronic device is executing in a trusted state, and verifying that a payment request is accurate by communicating with the electronic device.

28. The system of claim 26, wherein the electronic device comprises a mobile phone.

29. A non-transitory computer-readable medium having instructions which when executed on a computer perform a method comprising:
selecting a payment method from a list of payment methods for payment of a purchase request using an application on a mobile electronic device;
transmitting information for the selected digital credit card from the mobile electronic device to a payment reader for authorizing the purchase request using near field communication (NFC) for the transmitting of the information;
verifying the purchase request using a financial entity server in a cloud computing environment; and
completing the purchase request upon verification of one of a digital certificate for the selected digital credit card or verification of the electronic device.

30. The medium of claim 29,
wherein the payment method comprises a digital credit card,
wherein information for each credit card in a list of digital credit cards is stored on the mobile electronic device, wherein the stored information comprises one of actual credit card information, and a form of identifiers,
wherein the electronic device comprises a mobile phone, and
wherein the cloud computing environment comprises a private cloud computing environment for credit card issuer processing.
